(19) United States
(12) Patent Application Publication
(10) Pub. No.: US 2025/0238631 A1
(43) Pub. Date: Jul. 24, 2025

(54) SYSTEM AND METHOD FOR MONITORING LARGE LANGUAGE MODEL USAGE

(71) Applicant: WHITESOURCE LTD., Givatayim (IL)

(72) Inventors: Lior ZILBERG, Givatayim (IL); Avner LEWENSTEIN, Ramat-Gan (IL)

(21) Appl. No.: 18/419,102

(22) Filed: Jan. 22, 2024

(51) Int. Cl. G06F 40/40; G06F 8/30; G06F 8/71

(52) U.S. Cl. CPC G06F 40/40; G06F 8/30; G06F 8/71

(57) ABSTRACT

A method, system and computer program product, the method comprising: obtaining a prompt provided to at least one large language model (LLM) for generating programming code; obtaining a code snippet generated by the at least one LLM in response to the prompt; obtaining at least one difference introduced to programmer's code; determining a similarity degree between the code snippet and the at least one difference; determining a usage degree for code containing the at least one difference, based on the similarity degree for the at least one difference; and subject to the usage degree exceeding a predetermined threshold, taking an action.

### TECHNICAL FIELD

The present disclosure relates to the large language models (LLM) such as generative artificial intelligence (GAI) engines in general, and to a method and apparatus for monitoring the usage of LLMs in development environments.

### BACKGROUND

LLMs and in particular GAI engines relate to systems, realized for example as web applications or web sites capable of generating text, images, or other media, using generative models. Generative AI models learn the patterns and structure of their input training data and then generate new data that has similar characteristics.

Modern LLMs are adapted to receive natural language prompts as input and to output text complying to some degree and reliable to some degree with the prompt. The response may be a short answer, a sentence, a paragraph, or an essay.

In further uses, the LLMs may output computer code in response to a corresponding prompt. Thus, a large part of the code developers community uses or would like to use such tools on a daily basis, as part of their work. The users may input a prompt, receive a code segment, also referred to as snippet, and integrate it into their projects.

However, usage of machine generated code is not risk free. The code may be erroneous and simply wouldn't compile, or introduce inherent bugs to the user's program. Additionally, the code, especially if it is large, for example hundreds, thousands or more code lines, may introduce further risks, such as viruses, Trojan horses, or the like, without the user noticing that. Further risks may include liability issues, copyright issues, patent-related issues and others.

As a result, despite the great boost such tools provide to developers, and the significant reduction in development time, many software developing companies or other environments have completely banned the usage of such tools has been, thus denying the company and their employees of the great advantages of the tools.

### BRIEF SUMMARY

One exemplary embodiment of the disclosed subject matter is a computer-implemented method comprising: obtaining a prompt provided to a large language model (LLM) for generating programming code; obtaining a code snippet generated by the at least one LLM in response to the prompt; obtaining a difference introduced to programmer's code; determining a similarity degree between the code snippet and the difference; determining a usage degree for code containing the at least one difference, based on the similarity degree for the difference; and subject to the usage degree exceeding a predetermined threshold, taking an action. Within the method, the similarity degree is optionally determined subject to the difference being introduced to the programmer's code since the programmer's code was checked out of a source control system. Within the method, the similarity degree is optionally determined subject to the prompt being provided to the at least one LLM after a previous commit of the programmer's code to a source control system. Within the method, said determining is optionally performed upon a commit operation when entering code to a source control system. Within the method, the LLM is optionally a generative artificial intelligence (AI) engine. Within the method, the code optionally comprises a project. Within the method, the code optionally comprises a file. Within the method, the action optionally comprises one or more items selected from the group consisting of: displaying to a user a number of code lines within the code that are based on the code snippet provided by each of the at least one LLM, and displaying to the user code changes attributed to the at least one LLM. Within the method, the action optionally comprises one or more items selected from the group consisting of: providing to a user an indication that the at least one difference is attributed to the LLM, sending a message to the user, showing code changes, and blocking a build operation or a version creation. The method can further comprise sending a message to a supervisor of the user, to a compliance officer, or to another person in charge. Within the method, showing code changes optionally comprises enabling drill down into the code.

Another exemplary embodiment of the disclosed subject matter is a computerized apparatus having a processor, the processor being configured to perform the steps of: obtaining a prompt provided to a large language model (LLM) for generating programming code; obtaining a code snippet generated by the LLM in response to the prompt; obtaining a difference introduced to programmer's code; determining a similarity degree between the code snippet and the difference; determining a usage degree for code containing the difference, based on the similarity degree for the difference; and subject to the usage degree exceeding a predetermined threshold, taking an action. Within the apparatus, the similarity degree is optionally determined subject to the difference being introduced to the programmer's code since the programmer's code was checked out of a source control system. Within the apparatus, the similarity degree is optionally determined subject to the prompt being provided to the LLM after a previous commit of the programmer's code to a source control system. Within the apparatus, the determining is optionally performed upon a commit operation when entering code to a source control system. Within the apparatus, the LLM is optionally a generative artificial intelligence (AI) engine. Within the apparatus, the code optionally comprises a project or a file. Within the apparatus, wherein the action optionally comprises one or more items selected from the group consisting of: displaying to a user a number of code lines within the code that are based on the code snippet provided by each of the LLM, and displaying to the user code changes attributed to the LLM. Within the apparatus, the action optionally comprises one or more items selected from the group consisting of: providing to a user an indication that the at least one difference is attributed to the LLM; sending a message to the user, to a supervisor of the user, to a compliance officer, or to another person in charge; showing code changes comprising enabling drill down into the code; and blocking a build operation or a version creation.

Another exemplary embodiment of the disclosed subject matter is a computer program product comprising a computer readable storage medium retaining program instructions, which program instructions when read by a processor, cause the processor to perform a method comprising: obtaining a prompt provided to a large language model (LLM) for generating programming code; obtaining a code snippet generated by the LLM in response to the prompt; obtaining a difference introduced to programmer's code; determining a similarity degree between the code snippet and the difference; determining a usage degree for code containing the difference, based on the similarity degree for the difference; and subject to the usage degree exceeding a predetermined threshold, taking an action.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 is a flowchart of steps in of a method for determining whether a programmer's code contains code snippets generated by an LLM engine or based thereon, in accordance with some exemplary embodiments of the disclosure;

FIG. 2 is a schematic illustration of a screenshot demonstrating LLM engine usage, in accordance with some exemplary embodiments of the disclosure;

FIG. 3 is a schematic illustration of a screenshot demonstrating a detailed view of LLM engine usage, in accordance with some exemplary embodiments of the disclosure; and

FIG. 4 shows a block diagram of an apparatus for determining whether a programmer's code contains snippets of code provided by an LLM engine, in accordance with some exemplary embodiments of the disclosure.

### DETAILED DESCRIPTION

One technical problem dealt with by the disclosed subject matter is the need to benefit from the many advantages of using code generated by a large language model (LLM) in response to a prompt provided by a programmer, while reducing the associated risks.

The benefits include instantaneous generation of code according to defined specification. The code may be safe in some aspects, for example may not contain uninitialized variables, attempts to address array entries beyond the array size, or the like.

However, the code may also carry significant risks, which may increase dramatically for larger code segments. A user may be able, and may indeed review carefully a code segment containing up to a few dozens or hundreds of code lines. However, a user may not be able to review thoroughly thousands of code lines, containing interrelated functions, methods, objects or the like. This may lead to coding problems, such as uncompilable code, or code comprising bugs and in particular bugs which are hard to reconstruct. Moreover, such code may contain backdoors, Trojan horses, intended or unintended security problems, or others.

Since programmers often have to work under strict deadlines, they may sometime use LLMs to produce such code and incorporate it into their projects, in order to save time and effort, despite the associated risks.

In order to avoid the risks, companies or other organizations may completely ban the usage of LLMs, and thus also give up the significant advantages.

Thus, in order to enjoy the benefits of LLMs while mitigating the risks, it may first be required to identify whether a programming project contains code provided by an LLM, and which LLM. If so, it may be further required to identify which parts of the code have been provided by an LLM or based on code provided by an LLM. Once it is known that a particular LLM has been used, the associated benefits and risks may be evaluated and weighted, and appropriate actions may be taken.

One technical solution comprises a method and system for discovering the usage of LLM code in a programmer's project. Once it is known which parts of the programmer's code were generated by an LLM, and all the relevant data related thereto, an overall measure may be provided which indicates the extent of usage of LLM code within the user's code. The overall measure, and in particular if exceeds one or more predetermined thresholds, can enable the decision whether to take more educated actions, such as determining whether to allow the code, for example whether to let it be checked into the source control system, providing the code to another programmer for review, assessing the risks associated with the code or with the LLM, or the like.

In some embodiments, a collection of known LLM engines, such as web sites or applications may be maintained. Whenever a programmer accesses and uses any of the LLM engines, the usage details may be recorded. For example the prompt and the provided code, the access date and time, or the like.

Typically, the source code of a company or another entity is maintained in a source control system. When a programmer wishes to change a file, for example fix a bug or add functionality, the programmer checks out the file such that the programmer can make any changes without interrupting the work of other programmers who keep using the file as last checked in (also referred to a “committed”). When the programmer believes that the file as edited will not interfere with the work of the other programmers, the programmer can check in the file, thus making the changes available to the other programmers.

In accordance with some embodiments of the disclosure, at check in time, the differences between the file as edited by the programmer and the latest version as previously checked in may be determined. It is appreciated that a newly created file may be checked in for the first time, such that the differences may comprise the full contents of the file.

The differences, including but not limited to newly added segments, may then be compared to the code snippets provided to the programmer by the LLM models. In some embodiments, the code differences may be compared to the code snippets provided the LLM models since the file has been checked out, i.e., during the time the file was checked out for editing by the programmer.

It is appreciated that if multiple files are checked in together, for example as part of a project, the differences in any one or more files may be compared against the provided code snippets.

The comparison may be a fuzzy comparison rather than exact match. For example, differences in variable, function, or object names, or the names of other entities may be identified and ignored, the order of instructions may be altered, comments may be added, edited or removed, or the like. Thus, even if the programmer changed some entity names or introduced other changes, the differences may still be determined as comprising or being in compliance with the provided snippet, or a derivation therefrom.

Once a determination is made for each change, an overall usage degree may be calculated for the file or project. In some embodiments, the usage degree may be compared to a threshold.

The files or objects determined to comprise differences associated with code snippets provided by an LLM engine may then be checked in, or may be stored in a type of “quarantine” until approved by a person in charge.

A report indicating the usage of code based on LLM-provided code may be provided to the programmer or another user upon check in or upon a specific request.

The report may indicate the number of LLM code lines within a project, and further drill down may be enabled. Such drill down may present the total number of code lines and the number of code lines derived from an LLM engine per file, the specific LLM engine source used for each code segment, or the like. The specific prompt, the code snippet as provided by the LLM engine and the code snippet as appears in the programmer's code may be displayed.

In some embodiments, risk analysis may be performed, for example assessing security breaches, determining the liability and conditions of the organization, or the like.

One technical effect of utilizing the disclosed subject matter is the provisioning of a method and apparatus for determining the usage of code provided by LLM engines in a programmer's code, and identifying the specific LLM engine. The method and apparatus overcome difficulties such as modifications introduced to the LLM code by the programmer, which may make it harder to determine whether the LLM code has indeed been introduced to the programmer's code.

Another technical effect of utilizing the disclosed subject matter is the convenient access to the prompt and the code provided in response to the prompt, for easy review of the programmer's code as related to the LLM provided code.

Yet another technical effect of utilizing the disclosed subject matter is the option to take educated decisions about the code, for example whether to allow it, define the liability terms and risks, or the like.

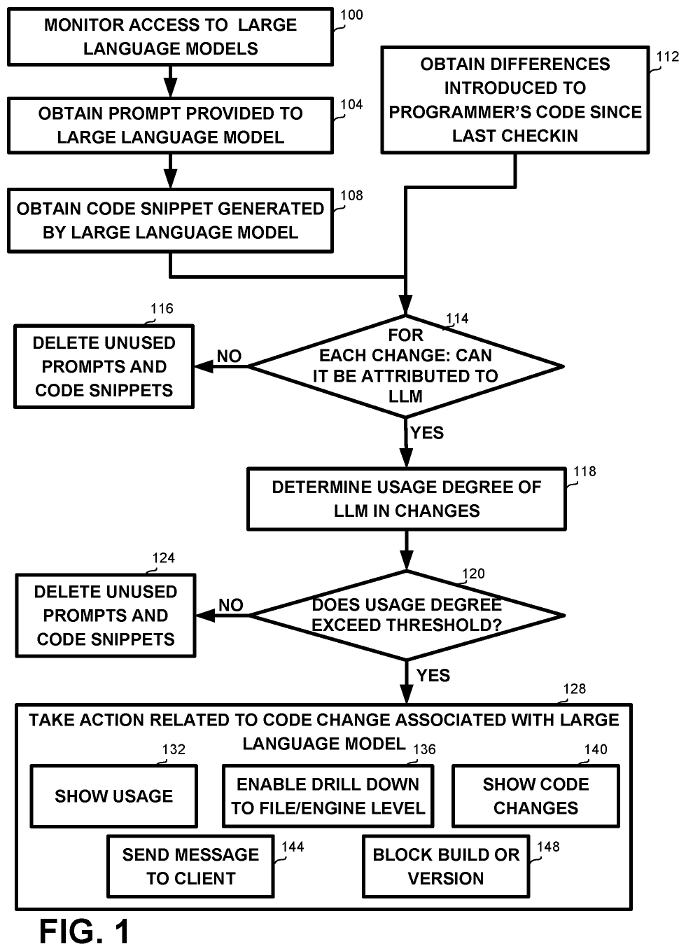

Referring now to FIG. 1 showing a flowchart of steps in a method for determining whether a programmer's code contains code snippets generated by an LLM engine or based thereon, in accordance with some exemplary embodiments of the disclosure.

At step 100, which may be performed continuously while the programmer is working, or while the programmer is using an Integrated Development Environment (IDE), the programmer's access to known LLM engines may be monitored. For example, a list of known LLM engines may be maintained, and access to any of them by any of the programmers in the organization may be monitored.

At step 104, upon a programmer introducing a prompt to the engine, the prompt may be captured and stored. The prompt may be stored with additional parameters, such as a unique ID, a file path where the modified file is stored on the developer's computing platform, creation time, the text itself, start line, end line, length, the repository name, or the like.

At step 108, a code snippet provided by the LLM engine may be obtained and stored. The snippet may also be stored with additional parameters, such as a unique ID, creation time, the snippet itself, start line, end line, length, the prompt or prompt ID, or the like.

In some embodiments, the snippet may be stored in association with the prompt. For example, each prompt and/or snippet may contain or point at the unique identifier of the corresponding snippet/prompt, respectively.

In some embodiments, if a code snippet was developed using repeatedly refined prompts, the session may also be assigned as identifier, and all prompts and snippets occurring throughout the session may be associated with the session identifier.

Step 112 may occur on specific points in time, such as when a programmer is checking his work into a source control system, such that other programmers may have access to the modified version. At step 112, the differences between the version about to be checked in and the version as was last checked out by the programmer may be obtained. It is appreciated that identifying the differences may be performed automatically by the underlying source control system.

At step 114, for each relevant change in the user's code, it may be determined whether the change can be attributed to an LLM engine. A relevant change my relate to addition of sections, and in some embodiments to additions larger than a predetermined threshold, such as a minimal number of characters, a minimal number of code lines, a minimal number of variable names, method names or other names appearing in the section, or the like.

In some embodiments, the determination of whether the change can be attributed to an LLM may be made upon exact match between the segment and the LLM snippet. In other embodiments, the determination may be made while taking into consideration approximate match, comprising for example altered names, removed comments, different instruction order, different distribution into functions, methods, objects or other entities, or the like. In some embodiments, for example in short code snippets, which may comprise less than a predetermined number of code lines, more strict similarity may be required between a difference and a code snippet. For example, complete identity may be required, complete identity with only changed names, or the like. In some embodiments, the matching may be determined using the same or analogous methodologies as used for determining open source usage, for example as described in U.S. Pat. No. 9,436,463 titled “System and Method for Checking Open Source Usage” incorporated herein by reference in its entirety and for all purposes.

In some embodiments, the differences may be compared only to the latest snippet provided in an LLM engine session, while in other embodiments the differences may be compared also to intermediate snippets, after which the programmer enhanced the prompt.

If the change cannot be attributed to an LLM engine, then at step 116 the unused LLM snippets and the associated prompts may be deleted.

If the change can be attributed to an LLM, then at step 118, a usage degree may be determined, which indicates to what degree the differences introduced to the programmer's code as detected at step 112, and as determined to be attributable to an LLM engine on step 114, amount to usage of the LLM engine. Thus, the determination whether each changed segment is attributable to an LLM engine may be aggregated, to obtain an LLM usage degree. The usage degree may be indicated in a number of lines originating from an LLM engine, the percentage of lines within a file or a project originating from an LLM engine, or the like.

Thus, while step 114 may be considered a local determination for a section of the code, step 116 may aggregate the similarity degrees and provide a global LLM usage degree for the user's code, whether it contains one or more files.

At step 120, it may be determined whether the usage degree exceeds a predetermined threshold.

In some embodiments, the usage degree may consist of multiple parameters, such as number or percentage of line of code generated by LLM, code sensitivity which may be determined for example by the number of locations calling the code, the project sensitivity (for example finance-related project may be considered more sensitive than car parking management application), or the like, and the decision at step 120 may refer to a single parameter or to a combination of or more parameters.

In some embodiments, the usage may be associated with a certainty level indicating the confidence that the lines are indeed provided by the LLM engine.

If the overall usage degree and/or the certainty level is below some predetermined threshold(s), at step 124 some action may be taken, such as store the prompts and/or snippets that can be attributed to LLM, or the like.

If the usage degree and/or the certainty level exceed the threshold(s), at step 128 one or more corresponding actions may be taken.

In one example, at step 132, the usage may be displayed to a user, for example over the display device as part of the user interface displayed when working with the IDE.

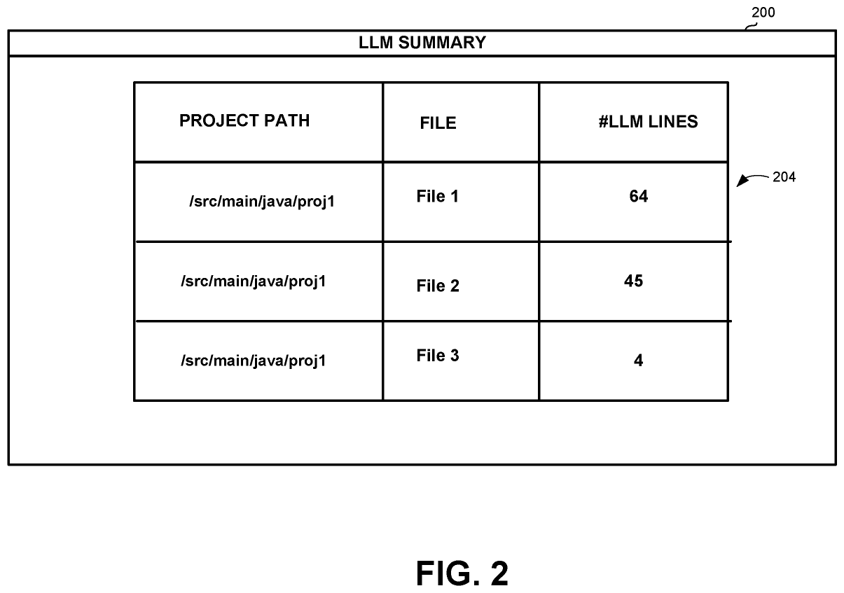

Referring now to FIG. 2, showing a schematic illustration of a screenshot demonstrating LLM engine usage, in accordance with some exemplary embodiments of the disclosure.

FIG. 2 shows table 200, which shows for a project the associated path and files, and for each file the number of LLM code lines within the file that are created by or derived from one or more code snippets provided by am LLM engine. For example, row 204 indicates that in File 2 of proj1 there are 64 code lines that are taken from an LLM provided snippet.

In another example, at step 136, the user may drill down to file/engine level.

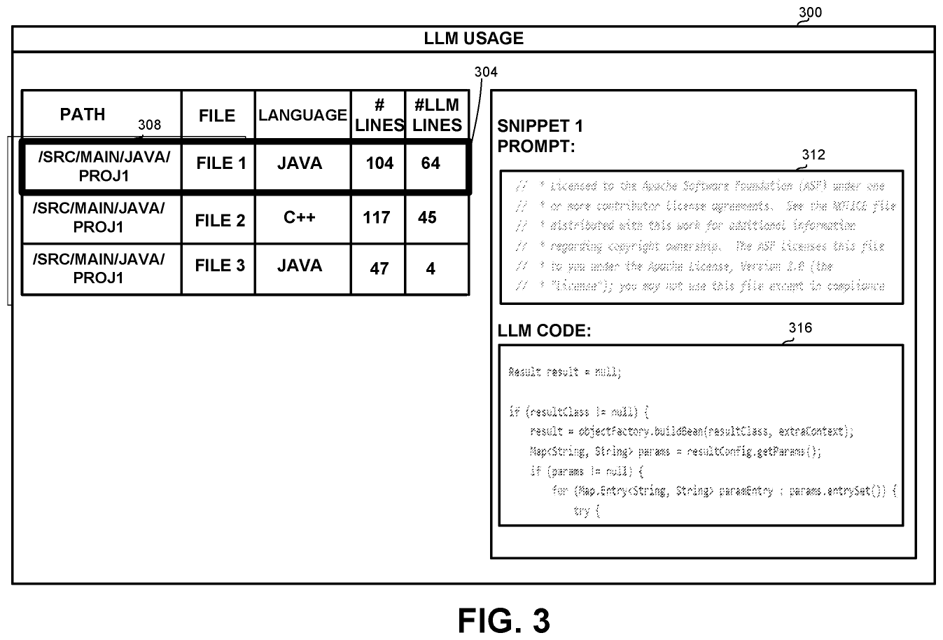

Referring now to FIG. 3, showing a schematic illustration of a screenshot 300 demonstrating a more detailed view of the LLM engine usage, in accordance with some exemplary embodiments of the disclosure.

Thus, in table 304, for each file the display shows the language, the total number of code lines, and the number of lines taken from an LLM engine, which may be a representation of the aggregated usage degree for the file.

The user may select a row, for example row 304. For the file associated with the selected row, File 1 in the example of FIG. 3, prompt 312 and LLM code 316 may be shown for each snippet used within the file.

In some embodiments, the characteristics of the used LLM engine that provide the snippet may also be displayed. In further embodiments, the code snippets may be grouped by the LLM engine, by project, or the like.

It is appreciated that the illustrations of FIG. 2 and FIG. 3 are non-binding but rather exemplary, and that different or further views may be design.

In yet another example, on step 140, the code changes may be displayed, optionally with color or pattern coding, such that the LLM code snippets and the changes introduced thereto by the programmer can be easily seen. For example the LLM code snippets may be shown in italic letters, or larger letters, and the changes introduced thereto may be shown by striking out deleted text, underlines added text, or the like.

In a further example, at step 144 a message may be sent to a user, such as an e-mail, an instant message, or the like, indicating the usage. The message may be sent to the programmer, a supervisor of the programmer, a compliance officer, or any other person or system assigned for the task.

In yet another example, at step 148, a “build” operation or version creation may be eliminated until the issue is resolved, for example by eliminating the offending code, by receiving an approval from a supervisor, or the like.

It is appreciated that the actions above are example only, and further or different actions may be taken. It is also appreciated that the thresholds of steps 114 and 120, as well as the actions may be subject to the user, such as the organization for which the code is developed, policy and decisions.

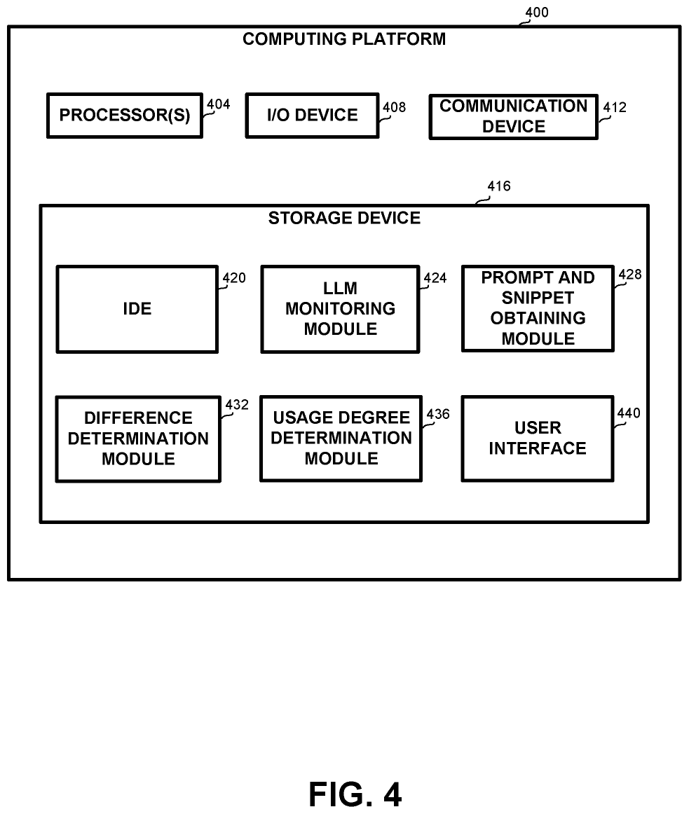

Referring now to FIG. 4, showing a block diagram of an apparatus for determining whether a programmer's code contains snippets of code provided by an LLM engine, in accordance with some exemplary embodiments of the disclosure.

The apparatus may comprise one or more computing platforms 400. Computing platform 400 may comprise one or more processors 404. Each of processors 404 may be a Central Processing Unit (CPU), a microprocessor, an electronic circuit, an Integrated Circuit (IC) or the like. Processor 404 may be utilized to perform computations required by the apparatus or any of its subcomponents.

In some exemplary embodiments of the disclosed subject matter, computing device 400 may comprise an Input/Output (I/O) device 408 such as a display, a pointing device, a keyboard, a touch screen, or the like. I/O device 408 may be utilized to provide output to and receive input from a user such as a programmer, an administrator, a compliance office or the like.

In some exemplary embodiments of the disclosed subject matter, computing platform 400 may comprise communication device 412 such as a network adaptor. Communication device 412 may enable computing platform 400 to communicate with other platforms such as one or more servers, storage devices, or the like. For example, an external storage device hosted by a computing platform in communication with computing platform 400 may comprise a source control system with all current and prior versions of all files of the projects of one or more programmers.

In some exemplary embodiments, computing platform 400 may comprise a storage device 416. Storage device 416 may be a hard disk drive, a Flash disk, a Random Access Memory (RAM), a memory chip, or the like. In some exemplary embodiments, storage device 416 may retain program code operative to cause processor 404 to perform acts associated with any of the subcomponents of computing platform 400, for example steps of the method of FIG. 1 above. The components detailed below may be implemented as one or more sets of interrelated computer instructions, executed for example by processor 404 or by another processor. The components may be arranged as one or more executable files, dynamic libraries, static libraries, methods, functions, services, or the like, programmed in any programming language and under any computing environment.

Storage device 416 may store, or be operatively in communication with another storage device storing an IDE 420 with which a programmer may edit, compile, integrate, execute, monitor or debug programs, and optionally additional actions. Storage device 416 may also store projects and files the programmer is working on, such as local versions of checked out files.

Storage device 416 may store, or be operatively in communication with another storage device storing an LLM monitoring module 424, for monitoring the usage of one or more programmers of a collection of known LLM engines.

Storage device 416 may store, or be operatively in communication with another storage device storing prompt and snippet obtaining module 428 for obtaining and storing on storage device 416 or elsewhere the prompts entered by a programmer to an LLM engine, and the provided code snippet. As detailed above, the prompt and the code may be stored with metadata including details such as unique IDs, dates, times, length, IDs of other entities or the like.

Storage device 416 may store, or be operatively in communication with another storage device storing difference determination module 432, for determining the differences between a file about to be checked in and the file as was previously checked out of the source control system (or the whole file in case of a new file).

Storage device 416 may store, or be operatively in communication with another storage device storing usage degree determination module 436, for determining the usage done in one or more of the detected differences based on one or more of the code snippets provided by the LLM engine. The determination may require exact usage of the code snippet or may allow certain changes, such as name replacements, instruction order changing, or the like.

Storage device 416 may store, or be operatively in communication with another storage device storing user interface 440, for displaying to a user, such as the programmer or a person in charge the usage done in LLM code. Thus, the number of LLM code lines may be displayed per project or per file, the details of the used LLM engine, the prompt and provided code, the programmers code with the lines originating from LLM engine being indicated for example in a different color or font, or the like. User interface 440 may also enable drill down of the information to any required level.

It is appreciated that in some embodiments user interface 440 may be implemented as part of IDE 420, such that a programmer can review the usage done in LLM code. Additionally or alternatively, one or more computing platforms within the organization may not be associated with a specific programmer, and may be used by another person such as a supervisor, an administrator, or a compliance officer for reviewing LLM code snippets used by programmers, using a user interface module which may be similar to user interface 440 but which may or may not be part of IDE 420.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
obtaining a prompt provided to at least one large language model (LLM) for generating programming code;
obtaining a code snippet generated by the at least one LLM in response to the prompt;
obtaining at least one difference introduced to programmer's code;
determining a similarity degree between the code snippet and the at least one difference;
determining a usage degree for code containing the at least one difference, based on the similarity degree for the at least one difference; and
subject to the usage degree exceeding a predetermined threshold, taking an action.

2. The method of claim 1, wherein the similarity degree is determined subject to the at least one difference being introduced to the programmer's code since the programmer's code was checked out of a source control system.

3. The method of claim 1, wherein the similarity degree is determined subject to the prompt being provided to the at least one LLM after a previous commit of the programmer's code to a source control system.

4. The method of claim 1, wherein said determining is performed upon a commit operation when entering code to a source control system.

5. The method of claim 1, wherein the at least one LLM is a generative artificial intelligence (AI) engine.

6. The method of claim 1, wherein the code comprises a project.

7. The method of claim 1, wherein the code comprises a file.

8. The method of claim 1, wherein the action comprises at least one item selected from the group consisting of: displaying to a user a number of code lines within the code that are based on the code snippet provided by each of the at least one LLM, and displaying to the user code changes attributed to the at least one LLM.

9. The method of claim 1, wherein the action comprises at least one item selected from the group consisting of: providing to a user an indication that the at least one difference is attributed to the LLM, sending a message to the user, showing code changes, and blocking a build operation or a version creation.

10. The method of claim 9, further comprising sending a message to a supervisor of the user, to a compliance officer, or to another person in charge.

11. The method of claim 9, wherein showing code changes comprises enabling drill down into the code.

12. A computerized apparatus having a processor, the processor being configured to perform the steps of:
obtaining a prompt provided to at least one large language model (LLM) for generating programming code;
obtaining a code snippet generated by the at least one LLM in response to the prompt;
obtaining at least one difference introduced to programmer's code;
determining a similarity degree between the code snippet and the at least one difference;
determining a usage degree for code containing the at least one difference, based on the similarity degree for the at least one difference; and
subject to the usage degree exceeding a predetermined threshold, taking an action.

13. The apparatus of claim 12, wherein the similarity degree is determined subject to the at least one difference being introduced to the programmer's code since the programmer's code was checked out of a source control system.

14. The apparatus of claim 12, wherein the similarity degree is determined subject to the prompt being provided to the at least one LLM after a previous commit of the programmer's code to a source control system.

15. The apparatus of claim 12, wherein the determining is performed upon a commit operation when entering code to a source control system.

16. The apparatus of claim 12, wherein the at least one LLM is a generative artificial intelligence (AI) engine.

17. The apparatus of claim 12, wherein the code comprises a project or a file.

18. The apparatus of claim 12, wherein the action comprises at least one item selected from the group consisting of: displaying to a user a number of code lines within the code that are based on the code snippet provided by each of the at least one LLM, and displaying to the user code changes attributed to the at least one LLM.

19. The apparatus of claim 12, wherein the action comprises at least one item selected from the group consisting of: providing to a user an indication that the at least one difference is attributed to the LLM; sending a message to the user, to a supervisor of the user, to a compliance officer, or to another person in charge; showing code changes comprising enabling drill down into the code; and blocking a build operation or a version creation.

20. A computer program product comprising a computer readable storage medium retaining program instructions, which program instructions when read by a processor, cause the processor to perform a method comprising:
obtaining a prompt provided to at least one large language model (LLM) for generating programming code;
obtaining a code snippet generated by the at least one LLM in response to the prompt;
obtaining at least one difference introduced to programmer's code;
determining a similarity degree between the code snippet and the at least one difference;
determining a usage degree for code containing the at least one difference, based on the similarity degree for the at least one difference; and
subject to the usage degree exceeding a predetermined threshold, taking an action.
